(19) United States
(12) Patent Application Publication
(10) Pub. No.: US 2001/0056497 A1
(43) Pub. Date: Dec. 27, 2001

(54) Apparatus and method of providing instant information service for various devices

(75) Inventors: Hong Cai, Beijing (CN); Leo Y. Liu, Cary, NC (US)

Correspondence Address: Steven Fischman, Scully, Scott, Murphy & Presser, 4000 Garden City Plaza, Garden City, NY, 11530, US

(73) Assignee: International Business Machines Corporation, Armonk, NY

(21) Appl. No.: 09/886,869

(22) Filed: Jun. 21, 2001

(30) Foreign Application Priority Data
Jun. 21, 2000 (CN) 00118677.9

(51) Int. Cl. G06F 15/16

(52) U.S. Cl. 709/230; 709/218

(57) ABSTRACT

An apparatus for providing instant information service for a plurality of devices, comprising: a network connecting unit (52) for fetching data from backend servers (41, 42, 43) and packaging the data into XML elements; a cache (53), caching the XML elements packaged by network connecting unit (52); and a controller (51), response to a request for information service from a client's, for fetching relevant XML elements from cache (53), and for the XML elements that cannot be fetched from cache (53), instructing the network connecting unit (52) to fetch the corresponding data from the backend servers and package the data into XML elements. Finally packaging all the obtained XML elements into a XML document and sending it back to the clients.

### BACKGROUND OF THE INVENTION

1. Technical Field

The present invention relates to the applications of WWW (World Wide Web), and specifically to apparatus and methods of providing instant information service to pervasive computing devices in WWW environments.

2. Prior Art

A conventional practice is that the information deliveries on the WWW are based on HTML (Hypertext Markup Language) because the design of HTML is primarily PC browser (IE or Netscape) oriented.

FIG. 1 shows a schematic diagram of a model of service provided based on the WWW. The application service mode of the WWW adopts the client/server architecture. Browsers (for example, the Internet Explorer of Microsoft and the Communicator of Netscape) running on PCs (personal computers) 141 or 142 send their requests to WWW application server 34 through the Internet (not shown in the diagram). Subsequently, WWW application server 34 will fetch the data either from the backend servers (41, 42, and 43) or from the cache 35, in accordance to the request received from the client. After the fetch of relevant data (that is to say the HTML document) is succeeded, WWW application server 34 will formulate a response with these data and return the response thus formulated to the client that issued the request.

In FIG. 1 showing a model of WWW application server, the data returned from the backend servers 41, 42, and 43, as well as those saved in the cache 35 form an HTML page. The HTML page requires an analysis by the HTML parser at the client's end before any display of the page is possible. Owing to the limited computation and communication capabilities of most of the pervasive computing device, HTML pages are not suitable for use in the majority of pervasive computing device.

Now the WWW architecture is continuously expanding to support the network connecting of all types of handheld devices. The traditional HTML file formats has failed to support all the required formats and displays of all these devices at the same time. After analyzing the requirements of end users, we are able to discover that: With respect to all types of handheld devices, it is the very critical information that is usually most needed by users. In comparison to the data needed by users, rich expressive forms like those provided by PC's are merely subsidiary matters. At present, a standard for the XML has been established to overcome the limitations of the HTML. The XML has provided a method of creating a customized markup language to adapt to specific types of documents. XML is becoming more and more effective in the development trend of Web, especially in the information exchanges. Strong support from the industry has already been won by XML.

When seen from the technical angle, as a type of expandable markup language for the description of structural documents, XML can describe structured data and allow the data to be separated from the actual presentation. When different devices access the identical service/data, critical data can be fetched first based on XML. Then, in view of the difference in the capabilities of various devices, different pages are generated through respective presentation manner and returned and displayed on respective handheld devices.

Nevertheless, with conveniences provided in the information exchanges, some problems are raised at the same time. One of these problems is in the performance aspect, owing to the fact that the processing of XML including the parse of XML and the generation of DOM (document object model) tree. Each node in the tree is an XML element. When large number of transactions exist in the servers, some degradation in the performance is inevitable.

In addition, the industry of providing service to pervasive computing devices is seeing rapid development. Here the term of pervasive computing device refers to any device possessing a certain amount of computation capability and communication capability. In addition to device with powerful functions like the PCs (personal computers), the term used here also include screen phones, mobile phones, laptop computers (IBM ThinkPads), palm computers (such as PalmPilot/IBM WorkPad), and short message systems etc. At the mean time, a variety of modes are being adopted to provide information service for the pervasive computing devices.

In FIG. 2, examples are presented to show the various service modes in existing technology. For instance, telephone 11 can obtain service from stock exchange 31, banking service 32, and cyber auction service 33 through the wired telephone network 21. STK mobile phone 12 and WAP mobile phone 13 obtain services from stock exchange 31, banking service 32, and cyber auction service 33 through the mobile phone network 22. PC 14 and palm computer 15 obtain services from stock exchange 31, banking service 32, and cyber auction service 33 through Internet 23.

It can be seen from the diagram shown in FIG. 2, in attempts to enable any service organization, such as stock exchange 31, to provide essentially the same services, such as inquiries on the current price of a stock with code number 0001, to different types of pervasive computing devices, proper design and development of appropriate software and hardware must be made in advance for those pervasive computing devices. This requirement came as a result of the fact that different types of pervasive computing devices diverge widely in their capabilities of computing, display, and communication. Besides, different communication protocols may be adopted in different network communication medium.

Therefore, if a kind of unified information service platform can be provided for applications on various different types of pervasive computing devices, there will be no necessity for the development of many information service systems in which each system is developed for one type of pervasive computing device alone. The advantage reaped would be a development boosting for information service trade.

When the needs of the users are considered seriously, we can discover that users usually lay their utmost concern on some critical information, such as current prices of stocks, information of accounts, weather situation, airline information etc. Lengthy HTML files are not their major concerns. Therefore the current trend is to expand the basic structure of Web, to support various types of pervasive computing device. A practical method of solution relies on the XML technology, in which the unit of the requesting information is an element of XML (in which the content of the critical information is already included), and not the whole document.

It can be seen in FIG. 2, if pervasive computing devices of different types obtain the same information service from a service organization, these pervasive computing devices are required to send requests to that service organization for essentially identical information in different formats. An example is PCs may request for rich information (including information in forms of video, audio and text etc.), while mobile telephones only need to request for audio information and not for image or video information. Palm computers may request for monochrome display but not audio information. Therefore, under situations where different types of pervasive computing devices obtain identical information service from one service provider, the requested information of these pervasive computing devices may meet with a certain degree of overlap.

A PC may request for complete XML documents comprising multimedia contents and display the contents with high resolution. A mobile telephone can only display few lines of text, and playback audio information. Palm computers like IBM WorkPad with Palm OS planted and devices with Win CE planted possess only certain size of display screen surface (from 160×160 to 320×240). Among the devices mentioned, some of them are equipped with black and white or monochrome displays and others have color displays.

If the fashionable WWW application service mode is used to compose different HTML home pages for different types of pervasive computing devices to access, this will result in inefficiency and extra burden on the servers.

In order to upgrade the performance of multi user access to the same service, usually the Web servers will apply the cache technology. That means, once a page is accessed, its content will be saved in the local storage (internal memory or magnetic disk) for period of time. In case there are other requests for accessing the same content, and the content has not been changed, the data can be directly fetched from local storage and returned to the user, without the necessity for connection with remote servers to fetch the data. However, in the traditional Web caching as mentioned before, the basic buffer unit is a complete HTML page. It is difficult for buffer units of such sizes to adapt to pervasive computing situations.

Evidently, WWW application service modes cannot be simply adopted as a kind of unified service platform for various pervasive computing devices.

The object of the present invention is to provide a system and method of high efficiently caching data in view of the characteristics of pervasive computing devices. Thus, pervasive computing devices of various types can instantly and efficiently access critical information based on expanded Web system structure. And on the basis of this method, content service providers can promote the level of service provision for the clients.

### SUMMARY OF THE INVENTION

For the purpose of implementing the above object, the present invention provides a system for providing information service to a variety of pervasive computing devices, the system comprising:

a network connecting unit, used for fetching data from the backend server and packaging the data into XML elements;

a cache for locally caching XML elements acquired by the network connection unit, and for providing future use; and

a controller for fetching relevant XML elements from the cache in response to information service requests of clients, for the XML elements that cannot be fetched from the cache, instructing the network connecting unit to fetch the corresponding data from the backend server and package them into XML elements, and finally packaging all the XML elements fetched into XML documents.

As fundamental data, these XML documents may be incorporated with appropriate format information (Style Sheet) of certain types of devices so that certain types of pages suitable for displaying one the devices will be generated, and returned to the users.

The present invention also provides a method for providing information service to a variety of pervasive computing devices, characterized by comprising the following steps that run in a system:

receiving a client's information service request;

fetching XML elements relevant to information service request from a local cache;

if relevant XML elements cannot be fetched from the local cache, fetching relevant data from the backend server and packaging these data into XML elements;

storing the XML elements in the local cache; and

packaging all the fetched XML elements into a XML document and returning it to the user.

Although the system and method in this invention are designed principally to provide information service to pervasive computing devices, the invention and its conception are also applicable to the use on WWW search engines. In the search engine servers, if XML elements are taken as a unit for caching, the operation efficiency of the search engine server will be promoted.

### BRIEF DESCRIPTION OF THE DRAWINGS

Preferred embodiments of the present invention will now be described, by way of example only, with reference to the accompanying drawings in which:

FIG. 1 shows schematically the mode of service provision based on WWW FIG. 2 shows the mode of providing various services in existing technology;

FIG. 3 is the schematic diagram showing a system for providing information service to pervasive computing devices according to this invention;

FIG. 4 shows in detail the internal structure of a cache system based on XML;

FIG. 5 is a schematic drawing describing the principle of the controllable caching technology, based on elements according to this invention;

FIG. 6 is a flowchart showing schematically the method of this invention for providing information service to pervasive computing devices.

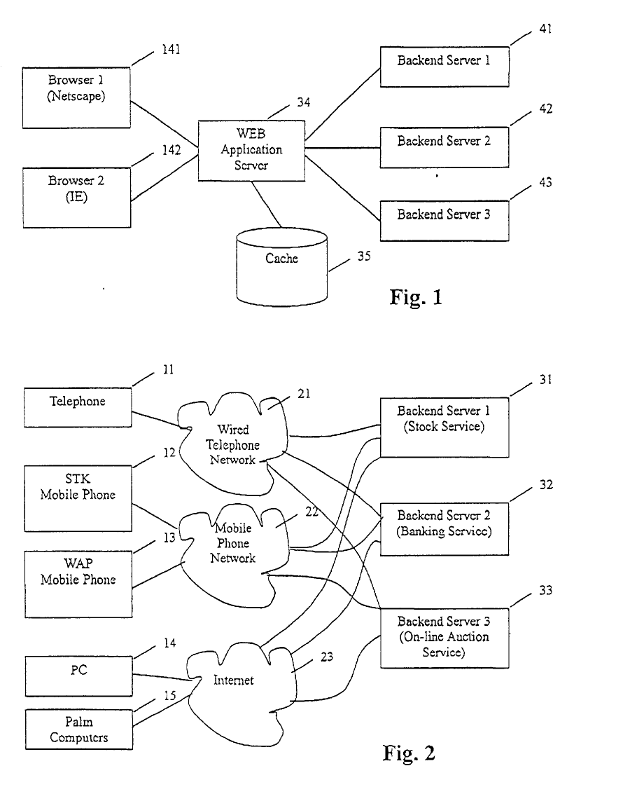

### DETAILED DESCRIPTION OF THE PREFERRED EMBODIMENTS OF THE INVENTION

Before going onto the detailed description of preferred embodiments, a brief introduction of XML is given in the following.

XML (Expandable Markup Language) is a standard issued by WWW Coalition (W3C)(http://www.w3.org) in February of 1998. The original intention (of W3C) for establishing the XML standard was in defining a standard for data exchange on the Internet. In the establishment, W3C adopted the strategy of simplifying SGML. On the basis of SGML, the syntax definition section was eliminated. The DTD section was appropriately simplified. A part of the Internet 's special components was also added. So XML is also a markup language. Essentially it is a subset of SGML. Owing to the fact that XML also has DTD, XML also can be regarded as the meta-language where other markup languages (such as HTML, WML) are derived from.

Through separating structure, content and presentation, the same XML source document only have to be written once, and it can be presented in different ways: on the display screens of computers, on the display screens of mobile telephones. It can also be translated into speech on device serving blind people etc. It can run on any communication product that may possibly be developed.

In XML, each document is an individual object and in the documents each element is also an individual object. Normally DTD (Document Type Definition) is used to specify the logic structure of documents. The author can use DTD to define a type of syntax for markup sets in documents, so as to enable the application programs for processing XML documents (such as XML parsers) to verify the proper usage of markups. DTD comprises sets of elements and their attributes, as well as instructions book for the relations between each element and other elements. Once an element has been defined, it can be associated with StyleSheets, Scripts, and HTML codes. By using XML in this manner, home page authors can define their own markups and attributes to identify document elements and allowing element auto-authentication to be implemented. The presentation of internal data structure is the DOM (Document Object Model). DOM enables a given XML page elements to be addressed as programmable objects. Essentially, DOM is the characterization of the tree structure of all the nodes in the XML document.

When WWW application servers process XML documents, usually great amount of work is done on parsing XML documents so as to extract parts of elements in documents that can be returned to the users as responses. Because XML documents are semantic documents, some information contained in them can be repeated and reused.

Now the preferred embodiments of this invention is described in detail.

The present invention applies not only to a system of providing information service to pervasive computing devices but also to any other systems.

FIG. 3 demonstrates schematically how this invention is used in systems providing information service to pervasive computing device. As shown in FIG. 3, PC (personal computer) 14 is connected to information service platform 50 through Internet 23. WAP mobile telephone 13 is connected to WAP gateway 24, through mobile telephone network 22, which is connected to information service platform 50 in turn. Palm computer 15 is connected to hand-held device gateway 25 through wired telephone network 21, which is connected to information service platform 50 in turn. Information service platform 50 is connected to the respective backend servers 41, 42 and 43 etc.

WAP gateway 24's function is to provide communication protocol translation and routing between mobile telephone network and information service platform 50. It provides the interface for WAP mobile telephones to access information service platform.

Hand-held device gateway 25's function is to provide communication protocol translation and routing between mobile telephone network 21 and information service platform 50. It provides the interface to access the information service platform for palm computers.

The working process of information service platform 50 is described as follows. First the information service requests originated from PC 14, WAP mobile telephone 13 or palm computer 15 are received from Internet 23, WAP gateway 24 or hand-held device gateway 25. The information service request may either be requests to multi resources or to a single resource. Then, corresponding information is acquired, in accordance to the received information service request, from their corresponding backend servers 41, 42, and 43 etc. Subsequently the acquired information is resolved into XML elements and is cached in units of XML elements. (On this point, this caching differs evidently from the caching in HTML page units currently adopted by WWW network.)

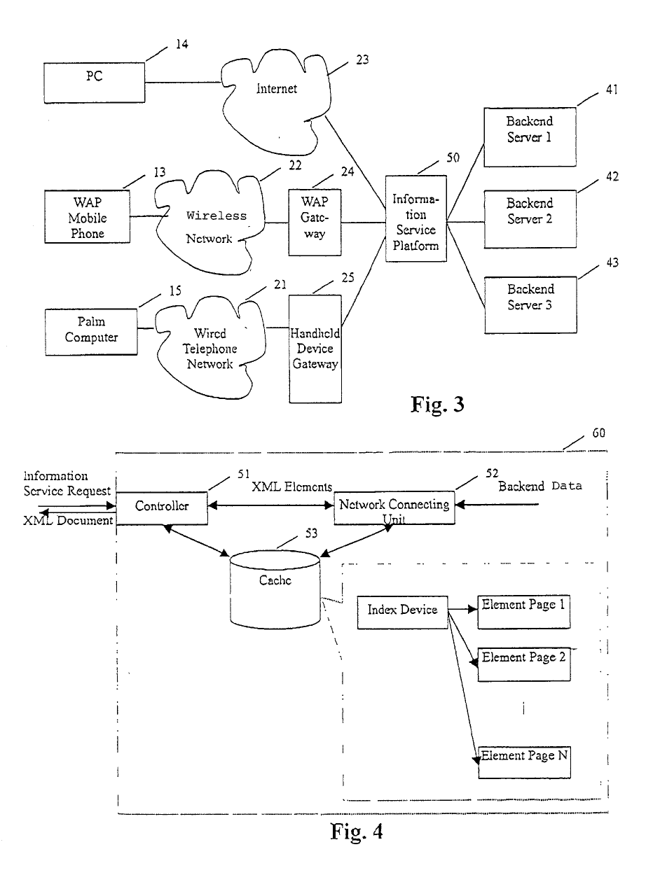

The important structural component of information service platform 50 is the cache system based on XML. (As shown by label 60 in FIG. 4) The cache system constructs an XML document with the cached XML elements or data directly acquired from backend servers. Then the XML document is returned to Internet 23, WAP gateway 24, or hand-held device gateway 25, as responses.

FIG. 4 shows in detail the internal structure of the cache system 60 based on XML. The cache system based on XML comprises a controller 51, a network connecting unit 52 and a cache 53.

The controller 51 receives information service request from outside. Then it determines whether the requested element is stored in cache 53 or not. Each XML element may be identified by a unique identifier (ID), whose logic format is URL: name of XML document: and name of element. If the requested element is already stored in cache 53, it will be directly fetched from cache S3. If the requested element is not stored in cache 53, controller 51 directs the networking unit 52 to request the relevant backend server for the corresponding data. Network connecting unit 52 will acquire the corresponding data from the backend server and then package the data into XML elements. Then the packaged element will be returned to controller 51 by the network connection unit 52. At the same time if the element satisfies certain caching rules, then the element will be stored in cache 53.

The controller 51 will construct an XML document with the requested element, after the elements are acquired. Then the XML document will be returned and given to the outside as a response to the information service request.

The element processing made by the controller 51 is actually the process of dynamic construction of a tree (that is the DOM tree). Each node of the tree corresponds to one element in the XML document.

As already described above, when different pervasive computing devices retrieve information from the same site (server), this information may meet with a certain degree of overlap. In accordance with the principles of this invention, the controller 51 parses the information coming from XML documents and performs caching with elements taken as the fundamental unit. If the next request contains elements having already been request in former transactions, these elements will be simply fetched from cache 53 and only those elements that have not been cached will be fetched from the backend servers.

The storage of the tree structure data in cache 53 may adopt a variety of modes. Different storage forms will not present any limitation to this invention. The existence of differences in storage modes does affect the speed of provision of elements from cache 53 to a certain degree. Under considering the promotion obtained in end to end speed through the adoption of taking XML elements as units in cache, this effect is neglectful.

As shown in FIG. 4, when XML elements are stored in cache 53, an index can be used to raise the speed of XML element extraction.

For the storage of XML elements in the cache, different control strategies may be adopted.

(1) Perform Caching According to the Depth.

According to this strategy, only elements of low level (for example the first and second depth) will be cached to save the capacity of the memory.

(2) Perform Caching According to the Medium.

According to this strategy, caching is only performed against the medium that requires the minimum of memory capacity (for example texts or black and white images).

(3) Weighted Caching.

According to this strategy, different weight values are set for elements of different depths or different medium. Caching is only performed against elements with weighted values lower than a preset value.

(4) Scalable caching.

Elements with different weighted values are cached in different cache of different levels.

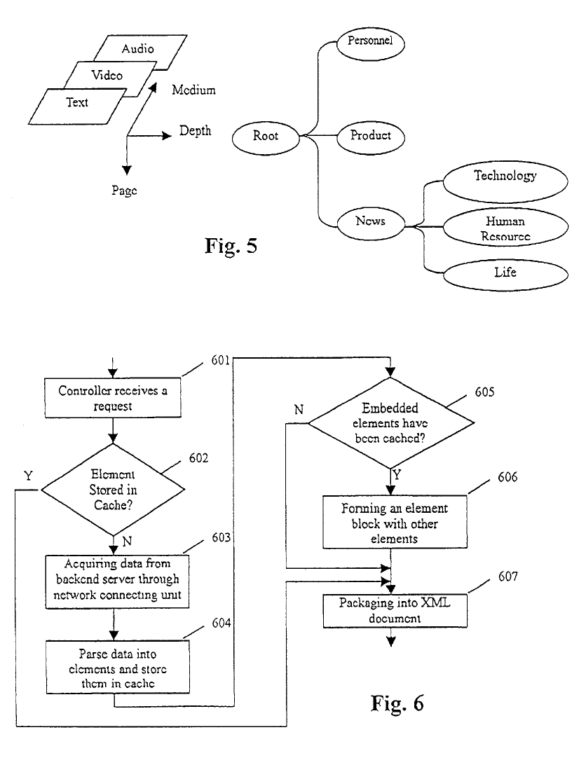

FIG. 5 shows a schematic diagram demonstrating the principle of the controllable caching technology based on elements according to this invention.

According to the principle of this invention, information is expressed as XML DOM trees, in which each node or leaf is a page comprising various types of elements (texts, images, audio information, and super link etc.).

The DOM tree shown in FIG. 5 is three-dimensional.

From left to right is the depth of elements that is similar to the depth of the WWW page;

From top to bottom, the items shown are respectively parallel elements with the same depths;

From inside to outside, the items shown are respectively the types of medium, for example texts, images, audio information, etc.

In the DOM tree, father nodes point toward the child nodes. The child nodes have hyperlinks to the father nodes.

A set of relevant elements constitutes a sub-tree. At any moment when a pervasive computing device makes an attempt to access the information set, accesses to the child tree will also be made. After the access, the elements belong to the child tree will be cached.

When two types of pervasive computing device access to the same tree are made, some overlap may exist. Therefore accesses to overlapped nodes are not necessary. The information expressed by overlapped nodes are already in existence in the cache. According to this method, even if the same tree rather than different child trees is accessed by two types of devices, retrieve information directly from the cache may be performed. In addition, according to this method, in case many different pervasive computing devices make access to different child trees, owing to this fact that the accessed child trees are certainly overlapped. Therefore when the different devices have already made accesses to the majority of the nodes, new device only have to directly retrieve information from the cache. Evidently, according to the principle of this invention, great amount of saving in information acquisition time is possible.

The use of Name Space together with annotation makes possible the distinction between elements with identical names but being slaves of different domains.

FIG. 6 shows a schematic diagram of a flowchart on this invention's method for providing information service to pervasive computing device. For example, the method can run on the information service platform 50 shown in FIG. 3.

In step 601, receiving client's request, the logic format of the request is URL: name of XML document: name of element.

In step 602, make a judgment on whether the element is stored in the cache or not.

If the result obtained on the judgment made in step 602 is yes, then turn to step 607. If the obtained result is no, then proceed to step 603.

In step 603, perform an acquisition of data from backend server through the networking unit.

Subsequently, in step 604, parse the acquired data into elements. Index the batch of elements and store them in the cache. In the cache, each element has its own unique ID.

In step 605, make a judgment on whether the elements embedded in this element have already been stored in the cache or not.

If the result obtained on the judgment made in step 605 is yes, then proceed to step 606. If the obtained result is no, then proceed to step 607.

In step 606, combine the element with other elements into element blocks.

Finally in step 607, package the element blocks into XML documents and returned to the clients as responses (to their request).

While the invention has been particularly shown and described with respect to preferred embodiments thereof, it will be understood by those skilled in the art that the foregoing and other changes in form and details may be made therein without departing form the spirit and scope of the invention.

Having thus described our invention, what we claim as new, and desire to secure by Letters Patent is:

1. An apparatus for providing instant information service for a plurality of devices (13, 14, and 15) characterized by comprising:
network connecting unit (52) for fetching data from backend servers (41, 42, 43) and packaging the data into XML elements;
cache (53) for caching the XML elements formed by said network connecting unit (52) by packaging; and
controller (51), in response to a request for information service from a client, for fetching relevant XML elements from cache (53), and for the XML elements that cannot be fetched from the cache (53), instructing the network connecting unit (52) to fetch corresponding data from backend servers and obtaining the XML elements formed by the network connecting unit (52) by packaging, and finally packaging all the fetched XML elements into a XML document and sending it back to the client.

2. The apparatus according to claim 1, characterized in that the cache (53) comprises an indexing mechanism for creating indices for all the XML elements stored in the cache (53).

3. A method of providing instant information to variety of apparatuses (13, 14, and 15) characterized in comprising the following steps performed on a server of:
receiving a request for information service from a device;
fetching XML elements which are relevant to the request for information service from a local cache (53);
if no relevant XML elements are fetched from the local cache, fetching corresponding data from backend servers, packaging the data into XML elements in the local cache (53); and
packaging all the fetched XML elements into a XML document and sending it back to the device.

4. The method according to claim 3, characterized by further comprising a step of creating indices for the XML elements stored in the cache (53).
